(19) United States
(12) Patent Application Publication
(10) Pub. No.: US 2004/0062557 A1
(43) Pub. Date: Apr. 1, 2004

(54) Optical receiver

(75) Inventors: Shigehiro Takashima, Tokorozawa (JP); Hirofumi Nakagawa, Yokohama (JP); Masanobu Okayasu, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: OpNext Japan, Inc., Yokohama-shi (JP)

(21) Appl. No.: 10/383,915

(22) Filed: Mar. 7, 2003

(30) Foreign Application Priority Data
Sep. 30, 2002 (JP) 2002-284731

(51) Int. Cl. H04B 10/06

(52) U.S. Cl. 398/209

(57) ABSTRACT

A variable optical attenuator VOA and a gain-clamped semiconductor optical amplifier GC-SOA are combined as an optical preamplifier. The variable optical attenuator is controlled so that a desired optical power is sent to the gain-clamped semiconductor optical amplifier or so that a desired optical power is sent to a photoelectric conversion stage. A optical power monitor is provided to compare a monitored value with a target value, and a variable optical attenuator control circuit controls the variable optical attenuator so that the deviation from the target value approximates 0.

### BACKGROUND OF THE INVENTION

The present invention relates to an optical receiver and more particularly to an optical receiver that has a semiconductor optical amplifier in a stage preceding a photoelectric converter device for use as an optical preamplifier.

To improve the minimum reception sensitivity of an optical receiver, a method of providing an optical preamplifier before the photoelectric converter device stage is widely used to optically amplify optical input signals before they are photo-electrically converted. In this case, an optical preamplifier is usually used in the constant output level control mode, that is, in the so-called ALC (Automatic Level Control) mode, for increasing the input dynamic range of the optical reception system in order to supply a constant optical power to a photoelectric conversion device in the following stage. In general, a rare earth doped fiber amplifier has been used in this field as an optical amplifier in an optical reception system. Especially, an Erbium doped fiber amplifier (EDFA) used for the 1550 nm band is famous. However, the fiber amplifier usually requires a case separate from that of a photoelectric conversion device because a fiber bundle with a limited bent-up radius must be excited. Therefore, it is difficult to combine them into one small case.

In addition to the fiber amplifier, a semiconductor optical amplifier (SOA) has attracted attention recently. Much effort has been made to develop a compact, power-saving, low-cost semiconductor optical amplifier that may be fabricated in the same facilities and process as those for a laser diode. It is also expected that the size of the semiconductor optical amplifier system may be reduced thorough monolithic integration with other semiconductor devices or through hybrid integration with other optical components.

A semiconductor optical amplifier may be designed for a wide wavelength range, 1200 nm to 1600 nm, for use in optical fiber communication by changing its composition. Unlike the rare earth doped fiber amplifier whose operating wavelength is limited by the atomic level structure, the operating wavelength design of the semiconductor optical amplifier may be freely changed by continuously changing the composition of compound semiconductors.

One of available publications dealing with a technology for building a high-sensitivity optical reception system using the semiconductor optical amplifier as the optical preamplifier is “An SOA-based automatic gain/loss controlled optical preamplifier for the wide input dynamic range”, pre-printed publication B-10-128 for 2001 general assembly of the Institute of Electronics, Information and Communication Engineers. This publication describes the method for performing the so-called ALC control, that is, the method for keeping the optical output of a semiconductor optical amplifier at a constant level by branching off the output optical signals of an optical preamplifier to find the average of the optical signal power and by controlling the bias current of the semiconductor optical amplifier so that the average value equals the reference voltage. The method disclosed in this paper uses an ALC control configuration in which the input to the optical reception system is input directly to the semiconductor optical amplifier and the gain is changed by controlling the injection current to the semiconductor optical amplifier to keep the output at a constant level. The characteristics of the semiconductor optical amplifier used in this configuration are affected greatly by the conditions such as the drive current, input optical signal power, and so on. Especially, this configuration produces the so-called pattern effect that dynamically changes the gain when a pattern of 1 (ON) or 0 (OFF) signals precedes. For this reason, when a sequence of 1 or 0 signals is received in an actual operation, it is difficult to ensure good optical signal amplification characteristics over a wide range of input level.

To suppress this pattern effect, a semiconductor optical amplifier (hereinafter called a gain-clamped semiconductor optical amplifier) was developed recently. This semiconductor optical amplifier, which has an optical feedback mechanism for generating laser oscillation, stabilizes the carrier density in the active layer to provide a constant gain and to reduce the pattern effect. An example of this gain-clamped semiconductor optical amplifier is described in “A Single-chip Linear Optical Amplifier”, Francis, D. A. et al., PD13-P1-3 vol. 4, Optical Fiber Communication Conference and Exhibit, 2001. U.S. Pat. No. 6,310,720 also discloses an optical amplifier module that uses a semiconductor optical amplifier.

Unlike a conventional semiconductor optical amplifier, a gain-clamped semiconductor optical amplifier has a reduced pattern effect and therefore provides better BER (Bit Error Rate) characteristics. Another advantage is that a change in gain is small even when the injection current fluctuates. However, because those advantages also mean a reduction in the number of signal gain adjustment means, controlling the signal gain becomes more difficult.

### SUMMARY OF THE INVENTION

The present invention combines a gain-clamped semiconductor optical amplifier (GC-SOA) and a variable optical attenuator (VOA) to control an optical level. By combining them, an optical preamplifier capable of providing a gain and controlling the gain/attenuation amount may be configured.

The VOA may be hybrid integrated with other optical parts. Serially connecting an optical preamplifier, which is a combination of the VOA and the GC-SOA, with a photoelectric conversion device makes it possible a compact optical receiver that could not be attained by a rare earth doped fiber amplifier used as a preamplifier in the related art.

Other objects, features and advantages of the invention will become apparent from the following description of the embodiments of the invention taken in conjunction with the accompanying drawings.

### BRIEF DESCRIPTION OF THE DRAWINGS

Preferred embodiments of the present invention will now be described in conjunction with the accompanying drawings, in which;

FIG. 1 is a block diagram showing an optical receiver in a first embodiment of the present invention;

FIG. 2 is a block diagram showing an optical power monitor and a variable optical attenuator control circuit of the optical receiver in the embodiment of the present invention;

FIG. 3 is a block diagram showing an optical receiver in a second embodiment of the present invention;

FIG. 4 is a block diagram showing an optical receiver in a third embodiment of the present invention;

FIG. 5 is a block diagram showing an optical receiver in a fourth embodiment of the present invention;

FIG. 6 is a block diagram showing a signal amplitude monitor and a variable optical attenuator control circuit of the optical receiver in the fourth embodiment of the present invention;

FIG. 7 is a block diagram showing an optical receiver in a fifth embodiment of the present invention;

FIG. 8 is a block diagram showing an optical receiver in a sixth embodiment of the present invention;

FIG. 9 is a block diagram showing an optical receiver in a seventh embodiment of the present invention; and

FIG. 10 is a block diagram showing an optical receiver in an eighth embodiment of the present invention.

### DESCRIPTION OF THE EMBODIMENTS

Some embodiments of the present invention will now be described using examples. In the embodiments described below, a solid line joining blocks indicates a line through which an optical signal flows, and a thin line indicates a line through which an electrical signal flows.

(First Embodiment)

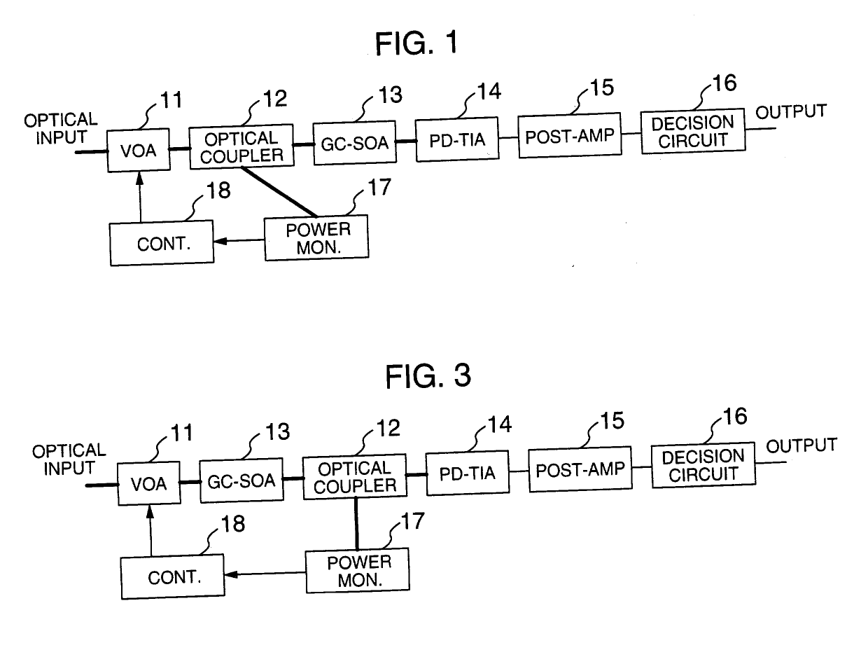

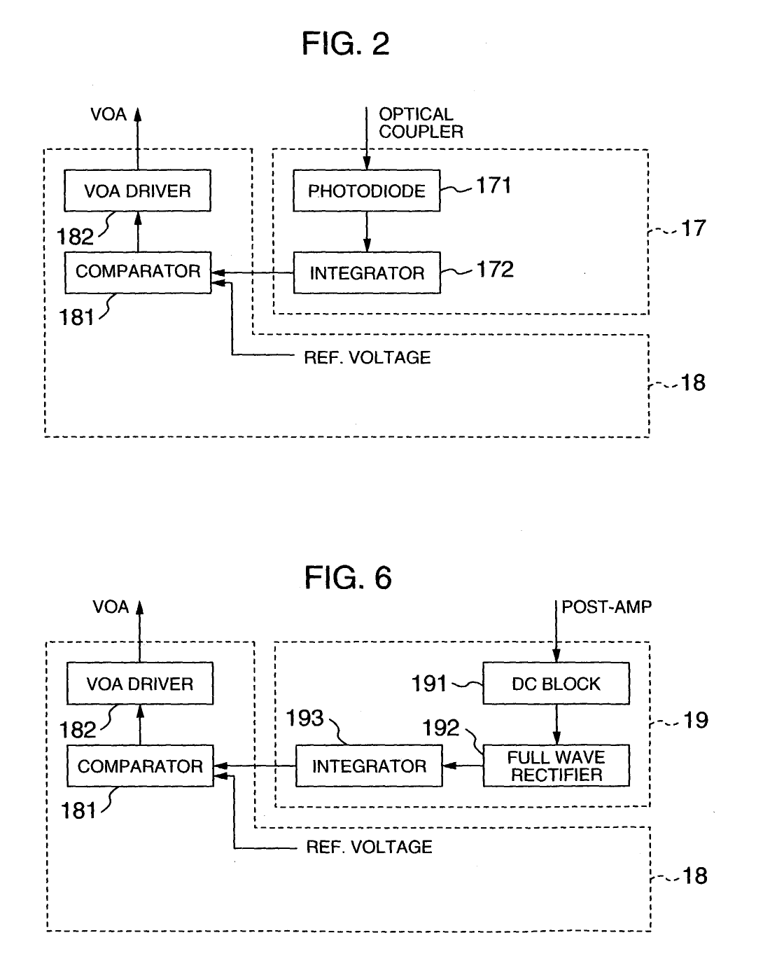

An optical receiver in a first embodiment of the present invention will be described with reference to FIGS. 1 and 2. FIG. 1 is a block diagram of an optical receiver. FIG. 2 is a block diagram of an optical power monitor and a variable optical attenuator (VOA) control circuit.

Referring to FIG. 1, optical input signals sent to the optical receiver are received first by a VOA 11. The VOA 11, which is controlled as will be described later, keeps the received optical input signals at an appropriate level and sends them to an optical coupler 12. The optical coupler 12 branches off the optical signals, most of which are sent to a GC-SOA 13. A part of optical signals branched off by the optical coupler 12 are sent to an optical power monitor (POWER-MON.) 17. The optical signals received by the GC-SOA 13 are amplified and then photo-electrically converted by a photodiode-integrated transimpedance amplifier (PD-TIA) module 14.

The signal gain of the GC-SOA 13 is approximately constant as described above. Therefore, to keep the level of optical input signals, which are sent to the photodiode-integrated transimpedance amplifier module 14, at a level near the optimum level, the level of the optical input signals sent to the GC-SOA 13 must be controlled. To do so, the optical power monitor 17 monitors the optical signals branched off by the optical coupler 12 in order to control the VOA 11 via a control circuit (CONT.) 18 so that the time average value becomes constant. That is, a feedback loop is formed in the stage preceding the GC-SOA 13.

In this configuration, when a large input signal is applied to the optical reception system, the VOA 11 generates a large loss to keep the level of optical signals, which are sent to the following stage, at a constant level. This makes it possible to configure an optical reception system that protects itself against a large input, that is, an optical reception system where the maximum reception sensitivity is high. In addition, because the GC-SOA 13 improves the minimum reception sensitivity, an optical reception system with a wide input dynamic range may be built.

Considering the reception sensitivity of a reception system, it is desirable that the minimum insertion loss of the VOA 11 be as low as possible. For the same reason, the insertion loss between the input port for the optical coupler 12 and the output port for the GC-SOA 13 should be low. Therefore, it is supposed that an optical coupler 12 with a large branch-off ratio between the output port for the GC-SOA 13 and the output port for the optical power monitor 17 is used. An optical coupler with a large branch-off ratio, for example, 90:10, 95:5, and 97:3, is commercially available. Considering the responsivility of the optical power monitor 17 and the control errors of the control circuit 18, an optical coupler with an appropriate branch-off ratio should be selected.

The optical power monitor 17 and the control circuit 18 will be described in detail with reference to FIG. 2. The optical power monitor 17 comprises a photodiode 171 and an integrator 172. The photodiode 171 receives optical signals branched off by the optical coupler 12 and converts them to an electrical current. Upon receiving the electrical current, the integrator 172 converts the current value to a voltage value to generate a time integration value. This time integration value corresponds to the time average value of the optical signal power over the time constant of the integrator 172. The output from the integrator 172 is sent to a comparator 181 in the control circuit 18 for comparison with the reference voltage. The comparator 181 outputs the deviation from the reference voltage of the input voltage to a VOA driver 182. The driver 182 drives the VOA 11 so that the deviation approximates 0. That is, when the time average value of the optical signal power is larger than the reference voltage, the driver 182 controls the VOA 11 so that the loss of the VOA 11 increases; on the other hand, when the time average value of the optical signal power is smaller than the reference voltage, the driver 182 controls the VOA 11 so that the loss of the VOA 11 decreases.

In addition to the so-called P (Proportional) control described above in which the control circuit 18 uses the deviation of the monitored value from the reference voltage to control the VOA, the PI control and PID control in which the control circuit 18 also uses the time integration value and the time differentiation value of a deviation are known. Those control methods may also be employed. Other control methods, if any, may also be employed.

Whichever control method is employed, the VOA 11 is controlled by the feedback loop described above and, as a result, the level of optical input signals sent to the GC-SOA 13 becomes constant. Because the GC-SOA 13 has an approximately constant gain, the output level of the GC-SOA 13 is approximately constant even if the optical input signal level of the reception system changes.

The photodiode-integrated transimpedance amplifier module module 14, which is an photo-electric converter, converts the optical signals output from the GC-SOA 13 to electrical signals using a photodiode (PD) that converts optical signals to electric currents and a transimpedance amplifier (TIA) that converts electric currents to electric voltages.

The output from the PD-TIA module 14 is amplified by a post-amplifier (POST-AMP) 15. If a limiting amplifier that limits the output signal amplitude to a fixed value or an AGC (Automatic Gain Control) amplifier that automatically changes the gain in such a way that the output signal amplitude is a fixed value is used as the post-amplifier, the amplitude of signals sent to the decision circuit 16 may be kept at a constant level even when there is a change in the extinction ratio of optical input signals received by the receiver or there is an optical level fluctuation that is too speedy to be processed by the optical level control loop. This improves the error ratio characteristics. It is also possible to use a simple linear amplifier with no function of a limiting amplifier or an AGC amplifier as a post-amplifier or to send an output of the PD-TIA directly to the decision circuit without using the post-amplifier.

The decision circuit 16 checks the on/off state, that is, performs code checking, of signals received from the post-amplifier 15 and outputs the result as the output of the optical reception system. Note that the decision circuit 16 need not be installed as a standalone device. If a device, for example, a demultiplexer (DEMUX), that follows the optical reception system has a sufficiently high input sensitivity, the front end part of that device performs the function of the decision circuit 16.

In the description of the embodiments above and below, the PD-TIA module 14 is used in which the PD and the TIA are integrated into one module that functions as a photoelectric conversion element, the PD and the TIA may be configured as separate modules. In addition, another type of amplifier, for example, a high impedance amplifier, may be used instead of the TIA.

When the optical signal input level of the optical receiver in this embodiment is low, the attenuation of the variable attenuator is minimized to provide an optical gain that improves the minimum reception sensitivity. On the other hand, when the optical signal input level is high, the variable optical attenuator generates a large loss to keep the level of optical signals, that are output to the following stage, at a constant level, thus making it possible to build an optical receiver whose maximum reception sensitivity is large.

(Second Embodiment)

An optical receiver in a second embodiment of the present invention will be described with reference to FIG. 3. FIG. 3 is a block diagram of the optical receiver.

Referring to FIG. 3, optical input signals sent to the optical receiver are input to a VOA 11. The VOA 11, which is controlled as will be described later, keeps the received input signals at an appropriate level and sends them to a GC-SOA 13. The optical output signals amplified by the GC-SOA 13 are branched off by an optical coupler 12 and are photo-electrically converted by a photodiode-integrated transimpedance amplifier module 14. A part of optical signals branched off by the optical coupler 12 are sent to an optical power monitor 17.

To keep the level of optical inputs, which are sent to the photodiode-integrated transimpedance amplifier module 14, at a level near the optimum value, the optical power monitor 17 monitors the optical signals branched off by the optical coupler 12 and controls the VOA 11 via the control circuit 18 so that the time average value becomes constant. The optical power monitor 17 and the control circuit 18 were described in the first embodiment with reference to FIG. 2. After the PD-TIA module 14, a post-amplifier 15 and a decision circuit 16 follow as in the first embodiment.

Considering the reception sensitivity of the reception system, it is desirable that the minimum insertion loss of the VOA 11 be as small as possible. On the other hand, unlike the first embodiment, the insertion loss of the optical coupler 12 may be designed in this embodiment in such a way that the insertion loss does not affect the reception sensitivity by allowing the GC-SOA 13 to have a flexible gain. Therefore, the branch-off ratio of the optical coupler 12 need not be large.

The VOA 11 is controlled in this embodiment in such a way that the output level of the GC-SOA 13 becomes constant and, as a result, the input to the photodiode-integrated transimpedance amplifier module 14 becomes constant. The GC-SOA 13, though not included in the feedback loop in the first embodiment, is included in the feedback loop in this embodiment. Therefore, the configuration in this configuration can compensate for the wavelength dependent gain and polarization dependent gain of the GC-SOA 13.

(Third Embodiment)

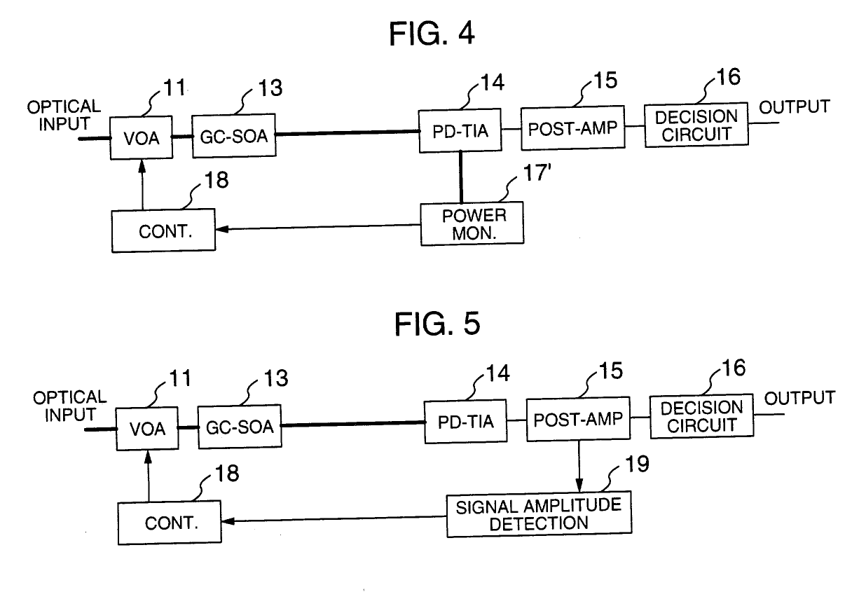

An optical receiver in a third embodiment of the present invention will be described with reference to FIG. 4. FIG. 4 is a block diagram of the optical receiver.

In the second embodiment, the optical coupler 12 is provided in the stage preceding the PD-TIA module 14 to monitor the power of the input to the PD-TIA module 14. However, the optical power monitor function, if provided in the PD-TIA module 14, may be used as an input monitor. That is, when the PD-TIA module 14 has an input level monitor terminal as shown in FIG. 4, this terminal may be used to obtain the optical input level signal for input to an optical power monitor 17′. In this case, because the signal indicating the optical input level has already been converted to an electrical signal, the photodiode 171 such as the one shown in FIG. 2 need not be provided in the optical power monitor 17′ but only an integrator 172 need be provided to find the average value.

If the optical power monitor function is not provided in the PD-TIA module 14, the output of the PD-TIA module 14 is branched off into two and one of them is sent to a post-amplifier 15 with the other to an optical power monitor 17′. When the PD-TIA module 14 has a two-branch output or a differential output (positive/negative phase), external branch means need not be provided. One of the output is sent to the post-amplifier 15, and the other to the optical power monitor 17′.

The embodiment shown in FIG. 4 also eliminates the need for an optical coupler for branching off optical signals and a photodiode for monitoring the optical signal power, thus providing a more compact, lower cost optical receiver.

(Fourth Embodiment)

An optical receiver in a fourth embodiment of the present invention will be described with reference to FIG. 5 and FIG. 6. FIG. 5 is a block diagram of the optical receiver, and FIG. 6 is a block diagram of a signal amplitude monitor and a variable attenuator control circuit.

Referring to FIG. 5, optical input signals sent to the optical receiver are received first by a VOA 11. The VOA 11, which is controlled as will be described later, keeps the received optical input signals at an appropriate level and sends them to a GC-SOA 13. The GC-SOA 13 amplifies the optical signals. In the rest of the configuration, a PD-TIA module 14 that is a module in which a photodiode (PD) and a transimpedance amplifier (TIA) are integrated, a post-amplifier 15, and a decision circuit 16 are included as in the first and second embodiments. The output of the PD-TIA module 14 is amplified by the post-amplifier 15. The output of the post-amplifier is branched off into two, and one of them is sent to the decision circuit 16 with the other to signal amplitude monitor means 19. The signal amplitude monitor means 19 outputs signals proportional to the amplitude of the output signals of the post-amplifier 15. A control circuit 18 controls the VOA 11 so that the output of the signal amplitude monitor means 19 becomes constant.

More specifically, the signal amplitude monitor means 19 first causes a DC block 191 to block DC components as shown in FIG. 6. The DC block 191 may be implemented through AC coupling via a capacitor. AC components are full wave rectified by a full wave rectifier 192 and is smoothed by an integrator 193. This allows signals proportional to the amplitude of the output signal of the post-amplifier 15 to be obtained.

The output of the signal amplitude monitor means 19 is sent to the control circuit 18. The control circuit 18 compares this output with the reference voltage to control the VOA 11 according to the deviation from the reference voltage. That is, when the input is larger than the reference voltage, the control circuit 18 increases the loss of the VOA 11; when the input is smaller than the reference voltage, the control circuit 18 decreases the loss of the VOA 11. To implement this function, the control circuit 18 comprises a comparator 181 and a VOA driver 182.

FIG. 6 shows an example of the internal configuration of the signal amplitude monitor means 19 and the control circuit 18. Any other circuit configuration and control method may also be used if the circuit has the function of monitoring the amplitude of the output signals of the post-amplifier and controlling the VOA 11 so that the amplitude becomes constant.

One of the characteristics of this embodiment is that, when a simply-configured linear amplifier with no function of a limiting amplifier or an AGC amplifier is used as the post-amplifier 15 or even when the output of the PD-TIA module 14 is sent directly to the decision circuit 16 without using the post-amplifier, the feedback control executed for the VOA 11 automatically keeps the amplitude of signals sent to the decision circuit 16 at a constant level.

That is, when a linear amplifier usually having characteristics better than those of a limiting amplifier is used as the post-amplifier in this embodiment, the AGC operation may be executed via the VOA 11 with no gain adjustment mechanism installed in the linear amplifier. The advantage is that a simply configured linear amplifier, if used as the post-amplifier, would stabilize the amplitude of the signals to be supplied to the decision circuit.

In addition to the GC-SOA 13 that is included in the feedback loop in the second embodiment, the PD-TIA module 14 and the post-amplifier 15 are included in the feedback loop in this embodiment. Therefore, even if a change in temperature affects the characteristics of those devices, the change in signal amplitude may be minimized.

(Fifth Embodiment)

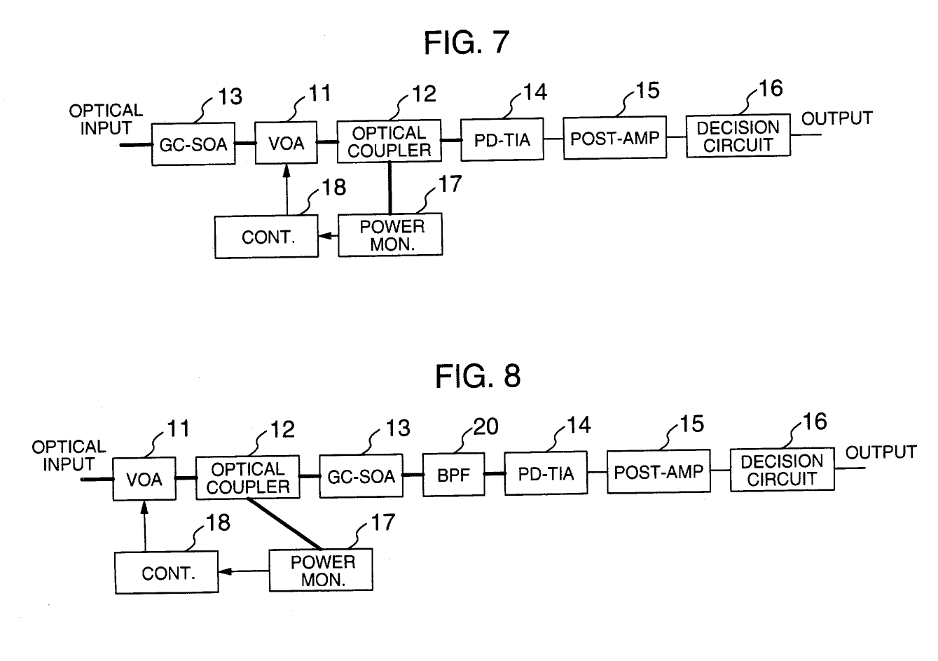

An optical receiver in a fifth embodiment of the present invention will be described with reference to FIG. 7. FIG. 7 is a block diagram of the optical receiver.

Referring to FIG. 7, optical input signals sent to the optical reception system are received first by a GC-SOA 13. The amplified optical output signals are sent to a VOA 11. The VOA 11 is controlled as will be described later. A part of output optical signals controlled at an appropriate level are branched off by an optical coupler 12 and are photo-electrically converted by the photodiode-integrated transimpedance amplifier module 14. The other part of the optical output signals branched off by the optical coupler 12 are sent to the optical power monitor 17.

To keep the level of optical signals to be input to the PD-TIA module 14 at a level near the optimum value, the optical power monitor 17 monitors the optical signals branched off by the optical coupler 12 and controls the VOA 11 via a control circuit 18 so that the time average value becomes constant. The block configuration of the optical power monitor 17 and the control circuit 18 is the same as that of the first embodiment shown in FIG. 2.

In this embodiment, the VOA 11 is controlled in such a way that its output level becomes constant. As a result, the input to the photoelectric converter becomes constant.

After the PD-TIA module 14, a post-amplifier 15 and a decision circuit 16 follow as in the first embodiment.

In the configuration described above, the optical coupler 12 is inserted into the stage preceding the PD-TIA module 14 to monitor the optical power. As described in the third embodiment, the optical power monitor of the PD-TIA module 14 may also be used to monitor the optical power. In addition, as described in the fourth embodiment, feedback control can also be performed so that the amplitude of photo-electrically converted electric signals becomes constant.

In this embodiment, because there is no VOA before the GC-SOA 13 that is an optical signal amplification stage, the noise figure (NF) of the optical preamplifier is lower than that in the first to fourth embodiments by the amount equal to the insertion loss of the variable optical attenuator. Therefore, one of advantages of this configuration is that the minimum reception sensitivity is better than that of other configurations by the amount equal to the insertion loss of the variable optical attenuator. On the other hand, because the input to the optical reception system is received by the GC-SOA 13 without making a level adjustment and, a saturation condition may be generated in the GC-SOA 13 at a large input time. This sometimes degrades the BER. Therefore, as compared with other embodiments of the present invention, this embodiment might decrease the input dynamic range.

(Sixth Embodiment)

An optical receiver in a sixth embodiment of the present invention will be described with reference to FIG. 8. FIG. 8 is a block diagram of the optical receiver.

The configuration and the control method of the functional blocks shown in FIG. 8 are basically the same as those of the first embodiment. Therefore, the configuration of this embodiment will be described below by referring to the configuration shown in FIG. 1. In FIG. 1, the output of the GC-SOA 13 is sent directly to the photodiode-integrated transimpedance amplifier module 14 that is a photoelectric conversion stage. In this embodiment, an optical band-pass filter (BPF) 20 is provided between a GC-SOA 13 and a PD-TIA module 14 to filter ASE (Amplified Spontaneous Emission) that is the optical noise of the GC-SOA 13.

As the optical band-pass filter 20 that is used in this configuration, a dielectric band-pass filter is commercially available that speedily blocks signals having non-transparency wavelengths through thin-film interference. The transmission central wavelength and the pass-band of the optical band-pass filter 20 should be selected so that optical signals with wavelengths within the optical signal wavelength range predetermined by the specification are accepted and so that signals with other wavelengths are blocked. This allows optical signals to be sent to the PD-TIA module 14 but prevents the ASE, which is an optical noise, from being sent to the PD-TIA module 14. The advantage of this embodiment is minimum reception sensitivity better than that in the configuration shown in FIG. 1. However, because the transmission wavelength of the optical band-pass filter 20 is fixed, the wavelength of signals to be accepted must be decided when the optical receiver is manufactured.

(Seventh Embodiment)

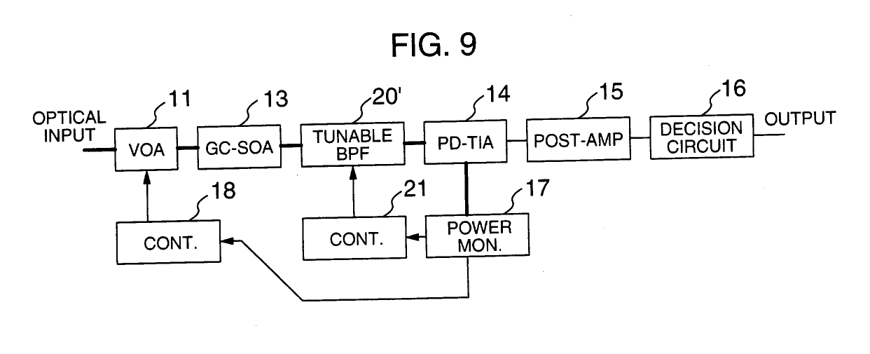

An optical receiver in a seventh embodiment of the present invention will be described with reference to FIG. 9. FIG. 9 is a block diagram of the optical receiver.

FIG. 9 shows an embodiment compatible with a wide input signal wavelength while making use of the ASE blocking function of the optical band-pass filter described in FIG. 8. The configuration and the control method of the functional blocks shown in FIG. 9 are the same as those in the third embodiment. In the third embodiment, the optical power sent from the photodiode-integrated transimpedance amplifier module 14 and monitored by the optical power monitor 17 is fed back to the VOA 11 via the control circuit 18. In this embodiment, the optical power is fed back also to a wavelength-tunable optical BPF 20′ that precedes the PD-TIA module 14 via a wavelength-tunable optical BPF control circuit 21. This wavelength-tunable optical BPF 20′ is provided to block ASE.

The wavelength-tunable optical BPF 20′ is an optical BPF whose passing wavelength is tunable by the control circuit 21. For example, the thin-film interference filter described above can change the transmission central wavelength by tilting the filter in relation to the incident direction of light. Of course, other wavelength-tunable optical BPFs, such as those that change the resonator length of the Fabry-Perot interferometer by a piezo device, may be used.

The power that enters the PD-TIA module 14 through the wavelength-tunable optical BPF 20′ is monitored by an optical power monitor 17. The optical power monitor 17 may have the block configuration shown in FIG. 2 described in the first embodiment. First, the control circuit 21 is controlled to maximize the optical power monitored by the optical power monitor 17. Because the optical power is maximized when the transmission wavelength of the wavelength-tunable optical BPF 20′ equals the wavelength of the optical signal, the wavelength-tunable optical BPF 20′ is tuned to the optical signal wavelength under this control.

Next, a VOA 11 is controlled via a VOA control circuit 18 to keep the optical power, obtained as a result of the control described above, at a constant level. This control method is described in detail in the third embodiment. In this embodiment, with the wavelength-tunable optical BPF stably tuned to the signal wavelength, the VOA 11 is controlled with a time constant slower than that of the feedback loop. Even when the input level or the wavelength of optical signals that are input to the optical reception system fluctuate, this method can keep the level of optical signals, which are input to the PD-TIA module 14, at a constant level while allowing the wavelength-tunable optical BPF to tune to the signal wavelength.

As described above, the signal used to control the VOA 11 and the wavelength-tunable optical BPF 20′ in this embodiment is the optical power monitored by the PD-TIA module 14 as in the third embodiment. However, the present invention is not limited to this embodiment. As described in other embodiments, the same effect may be obtained, with the use of an optical signal power monitored at other monitor points or the amplitude of electrical signals output by a post-amplifier, by controlling the wavelength-tunable optical BPF 20′ so that the value is maximized or by controlling the VOA 11 so that the value becomes constant.

(Eighth Embodiment)

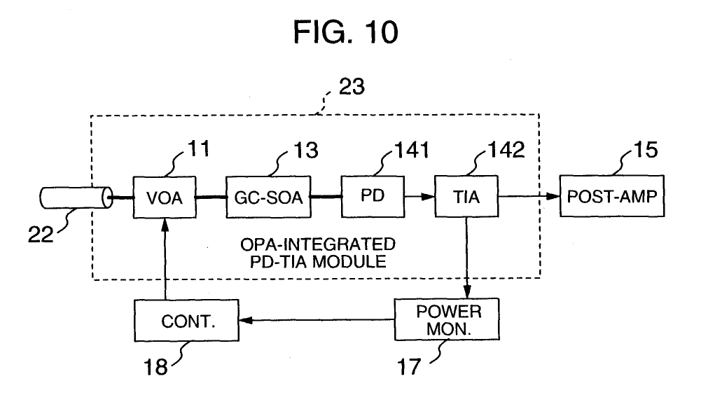

An optical receiver in an eighth embodiment of the present invention will be described with reference to FIG. 10. FIG. 10 is a block diagram of the optical receiver.

The configuration of the functional blocks shown in FIG. 10 is the same as that in the third embodiment, and the operation is also the same as that of the third embodiment. Therefore, the following describes this embodiment by referring to the third embodiment. In the third embodiment, the photodiode (PD) 141 and the transimpedance amplifier (TIA) 142 are integrated in the photodiode-integrated transimpedance amplifier module 14. In this embodiment, a VOA 11 and a GC-SOA 13 are also integrated in an OPA (Optical Preamplifier)-integrated PD-TIA module 23. This integration is possible because the VOA may be hybrid integrated with other optical parts and because the VOA, gain clamped semiconductor optical amplifier, and photoelectric conversion device may be serially connected into one case as a module. The solid line between those functional blocks in FIG. 10 indicates that optical signals flow and, therefore, this embodiment is the same as preceding embodiments. The transmission medium of optical signals may be an optical fiber or air, that is, a lens optical system.

The block configuration and operation, which are the same as those of the third embodiment, are omitted here.

An example of module integration of the configuration corresponding to the third embodiment is described above. In other embodiments described above, one or both of the VOA 11 and the GC-SOA 13 may be integrated into a PD-TIA module 14 in which the photodiode is included. In addition, the VOA 11 and the GC-SOA 13 may be integrated into a module separate from the PD-TIA module 14 for use as an optical amplifier module.

This embodiment provides a still more compact optical receiver.

As described above, the present invention provides a compact, highly-sensitive optical reception system whose sensitivity is less affected by the pattern effect and which has a wide input dynamic range.

It should be further understood by those skilled in the art that although the foregoing description has been made on embodiments of the invention, the invention is not limited thereto and various changes and modifications may be made without departing from the spirit of the invention and the scope of the appended claims.

We claim:

1. An optical receiver comprising:
a variable optical attenuator VOA; a variable optical attenuator control circuit; and a gain-clamped semiconductor optical amplifier GC-SOA,
wherein said variable optical attenuator control circuit controls an attenuation amount of said variable optical attenuator VOA based on an intensity of optical signals monitored before or after said gain-clamped semiconductor optical amplifier GC-SOA.

2. An optical receiver comprising:
an optical preamplifier including a variable optical attenuator VOA that variably attenuates received optical signals; an optical intensity monitor that monitors an intensity of optical signals output from said variable optical attenuator VOA; and a gain-clamped semiconductor optical amplifier GC-SOA that amplifies optical signals output from said variable optical attenuator VOA,
wherein said optical preamplifier controls said variable optical attenuator VOA in such a way that an output level of said optical preamplifier falls within a predetermined range.

3. An optical receiver comprising:
an optical preamplifier including a variable optical attenuator VOA that variably attenuates received optical signals; a gain-clamped semiconductor optical amplifier GC-SOA that amplifies optical signals output from said variable optical attenuator VOA; and an optical intensity monitor that monitors an intensity of optical signals output from said gain-clamped semiconductor optical amplifier GC-SOA,
wherein said variable optical attenuator VOA is controlled in such a way that the intensity of optical signals monitored by said optical intensity monitor falls within a predetermined range.

4. An optical receiver comprising:
a variable optical attenuator VOA that variably attenuates received optical signals; a gain-clamped semiconductor optical amplifier GC-SOA that amplifies optical signals output from said variable optical attenuator VOA; a photo-electric converter; and a signal amplitude monitor that monitors an amplitude of signals output from said photo-electric converter,
wherein said variable optical attenuator VOA is controlled in such a way that the amplitude of signals monitored by said signal amplitude monitor falls within a predetermined range.

5. An optical receiver comprising:
an optical preamplifier including a gain-clamped semiconductor optical amplifier GC-SOA that amplifies received optical signals; a variable optical attenuator VOA that attenuates the amplified optical signals; and an optical intensity monitor that monitors an intensity of optical signals output from said variable optical attenuator VOA,
wherein said optical preamplifier controls said variable optical attenuator VOA in such a way that an output level of said optical preamplifier falls within a predetermined range.

6. An optical receiver according to claim 1, said optical receiver further comprising:
an optical filter in a stage following said gain-clamped semiconductor optical amplifier GC-SOA.

7. An optical receiver according to claim 1,
wherein said variable optical attenuator control circuit and said gain-clamped semiconductor optical amplifier GC-SOA are integrated into one case as a module.
